(19) United States
(12) Patent Application Publication
(10) Pub. No.: US 2026/0368523 A1
(43) Pub. Date: Nov. 19, 2026

(54) TRAINING GENERATIVE NEURAL NETWORKS USING JACOBIAN SYMMETRY REGULARIZATION

(71) Applicant: GDM Holding LLC, Mountain View, CA (US)

(72) Inventors: Jyothi Swaroop Guntupalli, San Jose, CA (US); Subha Ramakrishna Gummadi, Mountain View, CA (US)

(21) Appl. No.: 19/679,144

(22) Filed: May 15, 2026

Related U.S. Application Data
(60) Provisional application No. 63/806,612, filed on May 15, 2025.

(51) Int. Cl. G06N 3/08; G06N 3/0475

(52) U.S. Cl. CPC G06N 3/08; G06N 3/0475

(57) ABSTRACT

Methods, systems, and apparatus, including computer programs encoded on computer storage media, for training a generative neural network using an objective function that includes a task term and a Jacobian symmetry regularization term. For example, the generative neural network can be configured as a diffusion neural network or a flow matching neural network.

### CROSS-REFERENCE TO RELATED APPLICATION

This application claims priority to U.S. Provisional Application No. 63/806,612, filed on May 15, 2025. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a training system implemented as computer programs on one or more computing devices in one or more locations that trains a generative neural network using an objective function that includes a task term and a Jacobian symmetry regularization term.

The subject matter described in this specification can be implemented in particular embodiments so as to realize one or more of the following advantages.

By using the described techniques to augment the training of a generative neural network with Jacobian symmetry regularization, the training system can more effectively train the generative neural network than existing training systems that do not apply Jacobian symmetry regularization as part of the training. In other words, the described techniques allow for improved training of a generative neural network that is configured to generate data items, thereby improving the field of machine learning.

In particular, the Jacobian symmetry regularization is implemented as a soft constraint during the training by way of a Jacobian symmetry regularization term included in an objective function that approximates a deviation of (i) a Jacobian matrix for a training vector field generated by the generative neural network from (ii) a symmetric Jacobian matrix. By reducing the deviation from the symmetric Jacobian matrix, the training system enables the generative neural network to learn a useful inductive bias toward data generation tasks.

Such an inductive bias accelerates the convergence of model parameters during training. Instead of blindly searching the vast space of all possible vector fields, the Jacobian symmetry regularization guides the generative neural network toward mathematically valid, conservative vector fields.

As such, the described techniques can increase the speed of training of generative neural networks, such that the training system can achieve faster convergence during the training of the generative neural networks. Thus, the amount of computing resources necessary for the training of the generative neural networks, e.g., the amount of processing resources used by the training process, can be reduced. The increased speed of training of generative neural networks can be especially significant for large-scale neural networks that are harder to train due to their immense number of parameters, or for training generative neural networks to generate data items with a high dimensionality.

From another point of view, this means that, for a given amount of computational resources employed, the quality (e.g., fidelity, coherence, and realism) of the data items that can be generated by a generative neural network as a result of the training can be improved. That is, the inductive bias learned by the generative neural network can enhance the quality of data items generated by the generative neural network after the training, i.e., during inference, e.g., in terms of Fréchet Inception Distance (FID) scores compared to unregularized baseline models when the data items are images.

In some cases, the described techniques can also improve the computational resource efficiency of a generative neural network after the training. For example, when configured as a diffusion neural network, the inductive bias learned by the generative neural network from the regularized training makes possible a reduction in the total number of reverse diffusion steps needed in the reverse diffusion process (and thus a reduction in computation resource consumption) before arriving at a final data item.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system and an example data generation system.

FIG. 2 is a flow diagram of an example process for training a generative neural network.

FIG. 3 is a flow diagram of sub-steps of one of the steps of the process of FIG. 2.

FIG. 4 is another flow diagram of sub-steps of the one of the steps of the process of FIG. 2.

Like reference numbers and designations in the various drawings indicate like elements.

### DETAILED DESCRIPTION

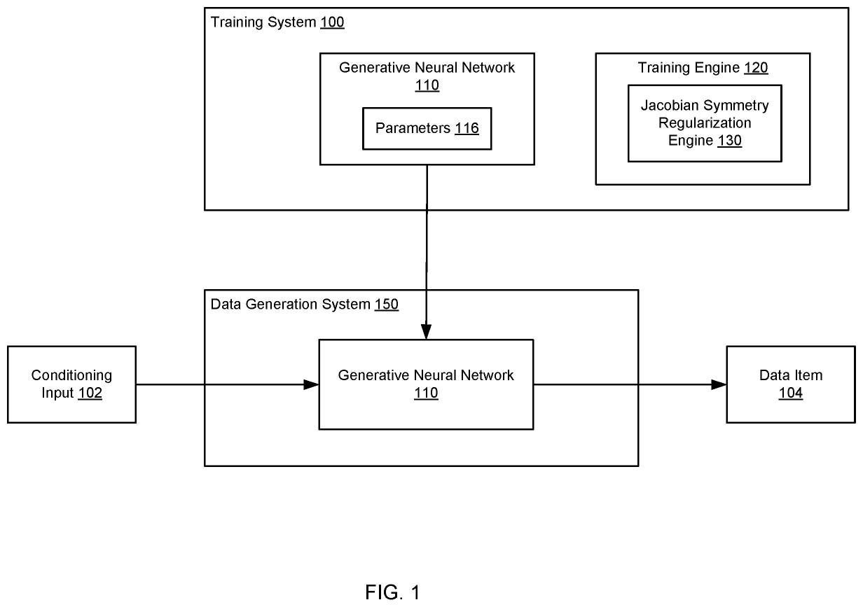

FIG. 1 shows an example training system 100 and an example data generation system 150. The training system 100 and the data generation system 150 are examples of a system implemented as computer programs on one or more computers in one or more locations, in which the systems, components, and techniques described below can be implemented.

The training system 100 obtains training data that includes a plurality of training data items, and trains a generative denoising neural network 110 (referred simply to as “a generative neural network 110” below) that has parameters 116 on the training data for deployment at the data generation system 150 to generate data items 104 conditioned on conditioning inputs 102.

That is, the training system 100 trains the generative neural network 110 to determine the trained values of the parameters 116 of the generative neural network then, after the training, the data generation system 150 uses the trained generative neural network 110 to generate data items in accordance with the trained values of the parameters 116 in response to requests for new data items. Each request includes, or is associated with, a conditioning input.

The generative neural network 110 can be any appropriate generative neural network that can execute an iterative denoising process, i.e., a denoising process over multiple steps, conditioned on a conditioning input 102 to map noise to a data item 104.

For example, the generative neural network 110 can be configured as a diffusion neural network. A diffusion neural network is a type of generative neural network that can be used to execute a reverse diffusion process during which noise is gradually removed from an initial representation of a data item, e.g., an initial representation that includes noise, to generate the data item. The reverse diffusion process includes a plurality of reverse diffusion steps.

The diffusion neural network can be any appropriate diffusion neural network that is configured to, at each reverse diffusion step, receive a diffusion input that includes a current (e.g., noisy) representation of a data item and a conditioning input and to generate a diffusion output for the reverse diffusion step that can be used to update (e.g., denoise) the current representation.

For example, the diffusion output can include a vector field that represents a score function, and a solver (e.g., a stochastic solver, a deterministic solver, or an ODE solver) can use the diffusion output to update the current representation to at least partially remove noise from the current representation.

In some implementations, the diffusion neural network performs a reverse diffusion process in output space, e.g., pixel space when the data items are images. In this example, when the data items are images, the data items (“representations”) operated on and generated by the diffusion neural network have values for each pixel that specify color values, e.g., RGB values or another color encoding scheme.

In some other implementations, the diffusion neural network performs a reverse diffusion process in latent space, e.g., in a latent space that is lower-dimensional than the output space. That is, the data items (“representations”) operated on by the diffusion neural network are latent representations and the values in the representations are learned, latent values, e.g., rather than color values when the data items are images.

In those other implementations, during training, the diffusion neural network can be associated with an encoder to encode training data items into the latent space and, after training and to generate new data items, a decoder neural network that receives an input that includes a latent representation of a data item and decodes the latent representation to reconstruct the data item. For example, the encoder and decoder can have been trained jointly on an image reconstruction objective, e.g., a VAE objective, a VQ-GAN objective, or a VQ-VAE objective.

The diffusion input at any given reverse diffusion step can also include data defining a noise level for the reverse diffusion step. Generally, each reverse diffusion step has a corresponding time step t and the noise level for the reverse diffusion step depends on the time step. For example, the noise level can be a function of the time step t. Examples of such functions include a linear function, a cosine function, a sigmoid function, a geometric function, and a polynomial function. In some implementations, data identifying the noise level, the time step, or both can be embedded using an appropriate neural network, e.g., a multi-layer perceptron (MLP) and used to condition the diffusion neural network as described below for the conditioning input.

For example, when the data item is an audio signal or an image, the diffusion neural network can be a convolutional neural network, e.g., a U-Net or other convolutional architecture. In some examples, the diffusion neural network can include one or more attention layer blocks interspersed among the convolutional layer blocks, where some or all of the attention blocks can be conditioned on a representation of the conditioning input. As another example, the diffusion neural network can be a Transformer neural network that processes the diffusion input through a set of self-attention layers to generate the diffusion output.

As another example, the generative neural network 110 can be configured as a flow matching neural network. A flow matching neural network is a type of generative neural network that can be used to execute a transformation process to transform a noise tensor that includes values each sampled from a noise distribution, into a data item. The transformation process includes a plurality of transformation steps.

The flow matching neural network can be any appropriate flow matching neural network that is configured to, at each transformation step, receive a flow matching input that includes a current (e.g., noisy) representation of the data item and a conditioning input and to generate a flow matching output that can be used to update (e.g., transform) the current representation.

For example, the flow matching output can include a vector field that represents a flow, and an ODE solver (e.g., a Euler or Heun solver) can use the flow matching output to update the current representation, transforming it toward the data item.

The flow matching input at any given transformation step can also include data defining a noise level for the transformation step. Generally, each transformation step has a corresponding time step t and the noise level for the transformation step depends on the time step. Rather than indexing a noise schedule like in reverse diffusion processes, in transformation processes, the time step t defines the weighting of the interpolation between the noise tensor and the data item. In some implementations, data identifying the noise level, the time step, or both can be embedded using an appropriate neural network.

The generative neural network 110 can be conditioned on the conditioning input 102 in any of a variety of ways.

As one example, the generative neural network can use an encoder neural network to generate one or more embeddings that represent the conditioning input and the generative neural network can include one or more cross-attention layers that each cross-attend into the one or more embeddings.

An embedding, as used in this specification, is an ordered collection of numerical values, e.g., a vector of floating point values or other types of values.

For example, when the conditioning input is text, the generative neural network can use a text encoder neural network, e.g., a Transformer neural network, to generate a fixed or variable number of text embeddings that represent the conditioning input.

When the conditioning input is an image, the generative neural network can use an image encoder neural network, e.g., a convolutional neural network or a vision Transformer neural network, to generate a set of embeddings that represent the image.

When the conditioning input is audio, the generative neural network can use, e.g., an audio encoder neural network, e.g., an audio encoder neural network that has been trained jointly with a decoder neural network as part of a neural audio codec, to generate one or more embeddings that encode the audio.

When the conditioning input is a scalar value, the generative neural network can use, e.g., an embedding matrix to map the scalar value or a one-hot representation of the scalar value to an embedding.

In some cases, the conditioning input includes multiple different types of inputs, e.g., two or more of text, images, bound values, or context embeddings.

In some of these cases, the generative neural network can generate one or more initial embeddings for each of the different types of inputs, i.e., using an appropriate encoder neural network as described above, and then process the initial embeddings for all of the different types of inputs using a Transformer encoder neural network to update each of the initial embeddings to generate a set of final embeddings. The one or more cross-attention layers within the generative neural network can then cross-attend into the set of final embeddings.

In others of these cases, different cross-attention layers within the generative neural network can cross-attend into embeddings of different types of conditioning inputs.

In yet others of these cases, the generative neural network can concatenate the initial embeddings of the different types of inputs along the sequence dimension and then the one or more cross-attention layers can cross-attend into the concatenated set of final embeddings.

As another example, the generative neural network can include one or more other types of neural network layers that are conditioned on the one or more embeddings. Examples of such layers include Feature-wise Linear Modulation (FILM) layers, layers with conditional gated activation functions, and so on.

Some examples of data items and conditioning inputs now follow.

Generally, the conditioning input characterizes one or more desired characteristics or properties of the data item, i.e., characterizes one or more target characteristics or properties that the final data item generated by the generative neural network should have.

The generative neural network 110 can be configured to generate any of a variety of data items 104 conditioned on any of a variety of conditioning inputs 102.

For example, the generative neural network can be configured to generate audio data, e.g., a waveform of audio or a spectrogram, e.g., a mel-spectrogram or a spectrogram where the frequencies are in a different scale, of the audio.

In this example, the conditioning input can be text or features of text that the audio should represent, i.e., so that the generative neural network serves as a text-to-speech machine learning model that converts text or features of the text to audio data for an utterance of the text being spoken.

As another example, the conditioning input can identify a desired speaker for the audio, i.e., so that the generative neural network generates audio data that represents speech by the desired speaker.

As another example, the conditioning input can characterize properties of a song or other piece of music, e.g., lyrics, genre, and so on, so that the generative neural network generates a piece of music that has the properties characterized by the conditioning input.

As another example, the conditioning input can specify a classification for the audio data into a class from a set of possible classes, so that the generative neural network generates audio data that belongs to the class. For example, the classes can represent types of musical instruments or other audio emitting devices, i.e., so that the generative neural network generates audio that is emitted by the corresponding class, or types of animals, i.e., so that the generative neural network generates audio that represents noises generated by the corresponding animal, and so on.

As another particular example, the data item can be an image, such that the generative neural network can perform conditional image generation by generating the intensity values of the pixels of the image. In general the conditioning input can specify one or more characteristics for the image.

In this particular example, the conditioning input can be a sequence of text and the output data item can be an image that describes the text, i.e., the conditioning input can be a caption for the output image.

As yet another particular example, the conditioning input can be an object detection input that specifies one or more bounding boxes and, optionally, a respective type of object that should be depicted in each bounding box.

As yet another particular example, the conditioning input can specify an object class from a plurality of object classes to which an object depicted in the output image should belong. As another example, the conditioning input can specify one or more images.

For example, the conditioning input can specify an image at a first resolution and the output data item can include the image at a second, higher resolution.

For example, the conditioning input can specify an image and the output data item can comprise a de-noised, enhanced, stylized, or otherwise edited version of the image.

As yet another particular example, the conditioning input can specify an image including a target entity for detection, e.g., a tumor, and the output data item can comprise the image without the target entity, e.g., to facilitate detection of the target entity by comparing the images.

As yet another particular example, the conditioning input can be a segmentation that assigns each of a plurality of pixels of the output image to a category from a set of categories, e.g., that assigns to each pixel a respective one of the category.

As yet another example, the conditioning input can be a different type of structured input, e.g., a mesh or a graph that specifies properties of the image to be generated.

More generally, the conditioning input can include one or more different types of inputs of one or more different modalities, e.g., only text, only one or more images, both text and one or more images, and so on.

As yet another example, the output data item can be a video. Again the conditioning input can specify one or more characteristics for the video.

As a particular example, the conditioning input can include text and the output data item can be a video described by the text.

As yet another particular example, the conditioning input can include one or more images and the output data item can be a video that completes the one or images, e.g., video starting from the one or more images.

More generally, the task of generating the output data item can be any task that outputs continuous data conditioned on a conditioning input. For example, the output can be an output of a different sensor, e.g., a lidar point cloud, a radar point cloud, an electrocardiogram reading, and so on, and the conditioning input can represent the type of data that should be measured by the sensor. Where a discrete output is desired this can be obtained, e.g., by thresholding the outputs generated by the diffusion neural network.

In some applications, the output data item can be used in a control task to control an action of a mechanical agent acting in a real-world environment to perform a mechanical task. For example, the output data item can be processed by a policy neural network of the agent to select one or more actions to be performed by the agent as part of the task. The agent may then perform the one or more actions. The output data item (e.g., image) can, for example, characterize a state of the real-world environment that is predicted to be obtained by the agent performing the one or more actions. The conditioning input can, e.g., specify a state of the real-world environment and the one or more actions. As another example the conditioning input can specify a state of the real-world environment and the output data item can be used to select one or more actions to be performed by the mechanical agent to perform a task (i.e., the diffusion neural network can represent an action selection policy).

The training system 100 includes a training engine 120. The training engine 120 includes a Jacobian symmetry regularization engine 130. The training engine 120 trains the generative neural network 110 on the plurality of training data items based on optimizing an objective function. The objective function includes a task term and a Jacobian symmetry regularization term.

When generating a data item during either training or inference, the generative neural network 110 generates one or more vector fields. The task term measures the quality of the vector fields generated by the generative neural network 110 during training, e.g., relative to target vector fields.

The Jacobian symmetry regularization term is computed by the Jacobian symmetry regularization engine 130, and is used by the training engine 120 during training to improve Jacobian symmetry in each vector field generated by the generative neural network 110 when generating the data item both during and after training, i.e., at inference.

For example, when the generative neural network 110 is configured as a diffusion neural network, the vector field can represent a score. In score-based diffusion neural networks, a “score” refers to the gradients of the log probability density function of a data item. A score can be represented as a tensor or another data structure that has the same dimension as the data item and encodes the direction in which the log probability density increases most rapidly. A score may also be referred to as a “score function.”

As another example, when the generative neural network 110 is configured as a diffusion neural network, the vector field can represent a v-parameterization for a noisy representation of the data item.

As another example, when the generative neural network is configured as a flow matching neural network, the vector field can represent a flow. The flow can be represented as a tensor or another data structure that has the same dimension as the data item and defines the direction and magnitude of the transformation from the data values in the noisy representation to the data values in the data item.

How the Jacobian symmetry regularization engine 130 computes the Jacobian symmetry regularization term will be described in more detail below further below, but in short, the Jacobian symmetry regularization term is an approximation of a deviation of a Jacobian matrix for the vector field from a symmetric Jacobian matrix.

The Jacobian matrix includes first-order partial derivatives of a vector field generated by the generative neural network with respect to data values in an input data item that is processed by the generative neural network to generate the vector field. For example, the Jacobian matrix can be computed as J_{θ}(x) [symbol] ∇ₓs_{θ}(x), where s_{θ}(x) represents a vector field generated by the generative neural network based on an input data item x.

A symmetric Jacobian matrix is a Jacobian matrix that is mathematically equal to its own transpose. This symmetry can be defined using either element-wise equality or basis-free characterization.

Element-wise equality: for every row index i and column index j, the matrix element at position (i,j) must exactly equal the element at position (j,i), expressed as

$${J}_{θ}^{i j} ( x ) = {J}_{θ}^{j i} ( x ) .$$

Basis-free characterization: for any two arbitrary projection vectors α and β, the inner product [symbol] J_{θ}(x)α,β [symbol] must equal [symbol] α,J_{θ}(x)β [symbol] . In other words, a bilinear form using the matrix will yield α^{T}J_{θ}(x)β−β^{T}J_{θ}(x)α=0.

By virtue of performing training that uses this Jacobian symmetry regularization term, the training engine 120 trains the generative neural network 110 to generate vector fields having Jacobian matrices that have a greater degree of symmetry compared to Jacobian matrices for vector fields generated by a baseline generative neural network that is trained based on optimizing a baseline objective function that does not include such a Jacobian symmetry regularization term. For example, the degree of symmetry can be determined as a measure of central tendency (e.g., an average or median) of the symmetry measures of the Jacobian matrices for a set of vector fields generated by the generative neural network 110 when generating a set of data items.

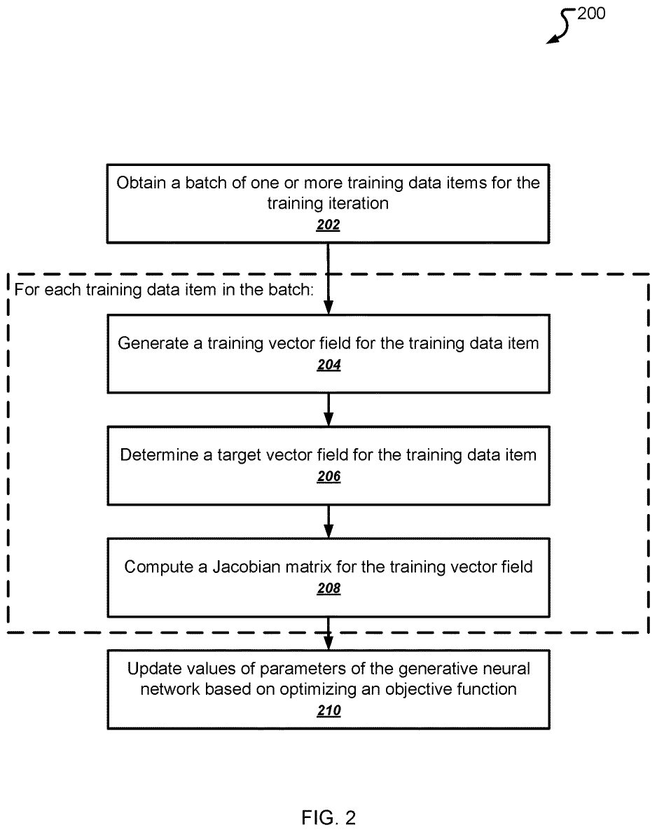

FIG. 2 is a flow diagram of an example process 200 for training a diffusion neural network neural network having parameters θ on training data. The training data includes a plurality of training data items and, for each training data item, a conditioning input that characterizes one or more desired characteristics or properties of the training data item. The training data items can include any types of data items, such as one or more of text data items, image data items, video data items, audio data items, and so on.

For convenience, the process 200 will be described as being performed by a training system of one or more computing devices located in one or more locations. For example, the training system 100 depicted in FIG. 1, appropriately programmed in accordance with this specification, can perform the process 200.

The training system can repeatedly perform iterations of the process 200 on different batches of training data items to update the parameters of the generative neural network. Each iteration of the process 200 may be referred to as a “training iteration.”

The system can continue performing iterations of the process 200 until termination criteria for the training of the generative neural network have been satisfied, e.g., until the parameters have converged, until a threshold amount of wall clock time has elapsed, or until a threshold number of iterations of the process 200 have been performed.

The training system obtains, from the training data, a batch of one or more training data items for the training iteration (step 202). The system will generally obtain different training data items at different iterations, e.g., by sampling a fixed number of training data items from a larger number of training data items at each iteration.

Steps 204-208 are performed for each of the one or more training data items in the batch.

The training system processes a training input that corresponds to the training data item using the generative neural network to generate a training vector field s_{θ}(x) for the training data item (step 204).

The training input includes an input data item x. The input data item can be a noisy representation of the training data item. The training input can also include a conditioning input (or data derived from the conditioning input) that characterizes one or more desired characteristics or properties of the training data item. The training input can further include data defining a time step.

How the noisy representation of the training data item is generated, as well as what the training vector field represents, may vary depending on the configuration of the generative neural network.

For example, when configured as a diffusion neural network, the noisy representation can be generated based on adding noise to the training data item (or a latent representation of the training data item) in accordance with a noise schedule and a time step. The training vector field can represent a predicted score, which includes the predicted gradients of the log probability density function of the training data item.

As another example, when configured as the diffusion neural network, the training vector field can represent a predicted v-parameterization for the noisy representation of the training data item.

As another example, when configured as a flow matching neural network, the noisy representation can be an interpolated version of the training data item and a noise tensor that includes values each sampled from a noise distribution, where the weighting of the interpolation depends on a time step. The training vector field can represent a predicted flow, which defines a predicted direction and magnitude of the transformation from the data values in the noisy representation to the data values in the training data item.

The training system determines a target vector field for the training data item (step 206). The content of the target vector field may vary depending on the configuration of the generative neural network.

For example, when configured as the diffusion neural network, the target vector field can represent a target score. The target score can be a noise tensor defining the noise that was added to the training data item (or a latent representation of the training data item), or can be a scaled version of the noise tensor.

As another example, when configured as the diffusion neural network, the target vector field can represent a target v-parameterization for the noisy representation of the training data item, e.g., a linear combination of the training data item and the noise added to the training data item, each weighted by a corresponding time-dependent scaling factor tied to the noise schedule.

As another example, when configured as the flow matching neural network, the target vector field can represent a target flow. The target flow defines a target, i.e., ground truth, direction and magnitude of the transformation from the data values in the noisy representation to the data values in the training data item.

The training system computes a Jacobian matrix for the training vector field (step 208). The Jacobian matrix, which can be computed as J_{θ}(x) [symbol] ∇ₓs_{θ}(x), includes first-order partial derivatives of the training vector field generated by the generative neural network with respect to data values in the input data item.

The training system updates values of parameters of the generative neural network based on optimizing an objective function (step 210).

The objective function includes, for each of the one or more training data items in the batch, (i) a task term that is based on the target vector field and (ii) a Jacobian symmetry regularization term that approximates a deviation of the Jacobian matrix for the training vector field from a symmetric Jacobian matrix.

For example, the overall objective function can be a sum or a weighted sum of the two terms, where each term is weighted by a corresponding weight. In some recommendations, one or both of the weights are fixed, e.g., they can be determined through a hyperparameter sweep prior. In some implementations, one or both of the weights are dynamic, e.g., the weight for the Jacobian symmetry regularization term can be exponentially decaying weights that decrease as the total number of training iterations increase.

Thus, the training system computes gradients of the task term with respect to the parameters of the generative neural network, computes gradients of the Jacobian symmetry regularization term with respect to the parameters of the generative neural network, and then applies an optimizer to the gradients of the task term and the gradients of the Jacobian symmetry regularization term to update the values of parameters of the generative neural network. Any optimizer can be used. Examples of optimizers include stochastic gradient descent, RMSprop, Adafactor, Adam, and Adam with weight decay (“AdamW”) optimizer.

The task term can be evaluated as any appropriate loss term that is suitable for training the generative neural network on the training data items.

For example, when the generative neural network is configured as a diffusion neural network, the task term can be evaluated as a diffusion loss term that depends on a difference between the training vector field and the target vector field, or a difference between the training vector field and another vector field derived from the target vector field.

An example of the diffusion loss term is described in Hoogeboom, Emiel, Jonathan Heek, and Tim Salimans. “Simple diffusion: End-to-end diffusion for high resolution images.” International Conference on Machine Learning. PMLR, 2023.

As a particular example, the diffusion loss term can be evaluated as a score matching loss term. An example of this is described in Song, Yang, and Stefano Ermon. “Generative modeling by estimating gradients of the data distribution.” Advances in neural information processing systems 32 (2019).

As another particular example, the diffusion loss term can be evaluated as the diffusion denoising loss term. An example of this is described in Ho, Jonathan, Ajay Jain, and Pieter Abbeel. “Denoising diffusion probabilistic models.” Advances in neural information processing systems 33 (2020): 6840-6851.

As another example, when the generative neural network is configured as the flow matching neural network, the task term can be evaluated as a flow matching loss term that depends on the training vector field, a difference between the target vector field and the noise tensor, or both.

Examples of the flow matching loss term include those described in Lipman, Yaron, et al., “Flow matching for generative modeling.” arXiv preprint arXiv: 2210.02747 (2022), Albergo, Michael S., et al., “Building normalizing flows with stochastic interpolants.” arXiv preprint arXiv: 2209.15571 (2022), and Liu, Xingchao, et al., “Flow straight and fast: Learning to generate and transfer data with rectified flow.” arXiv preprint arXiv: 2209.03003 (2022).

The Jacobian symmetry regularization term is used in addition to the task term to encourage the Jacobian matrices for the training vector fields to be symmetric.

Some implementations of the training system can determine this regularization term through exact computation, which involves evaluating the full Jacobian matrix and measuring its difference from its transpose.

For exact symmetry, every element in the Jacobian matrix must equal its transposed counterpart across all row (i) and column (j) indices:

$${J}_{θ}^{i j} ( x ) \approx {J}_{θ}^{j i} ( x ) .$$

To penalize the generative neural network for asymmetry in the training vector fields, the exact regularization term can evaluate a norm, e.g., a squared Frobenius norm, of the difference between the full Jacobian and its transpose:

$${‖ {J}_{θ} ( x ) - {J}_{θ}^{T} ( x ) ‖}_{F}^{2} ) ,$$

where the matrix representing this exact deviation is expressed as ΔJ [symbol] J_{θ}(x)−J_{θ}^{T}(x).

Explicit computation of the Jacobian matrix by performing d backward passes through the generative neural network, where d is the dimensionality of the input data item, incurs significant computational resource overhead due to the way automatic differentiation and the generative neural network operate.

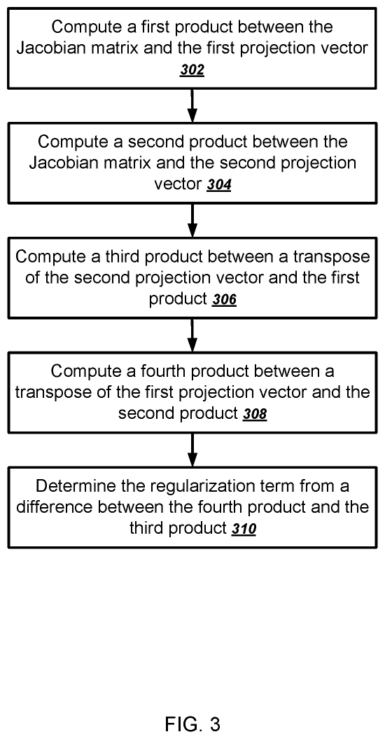

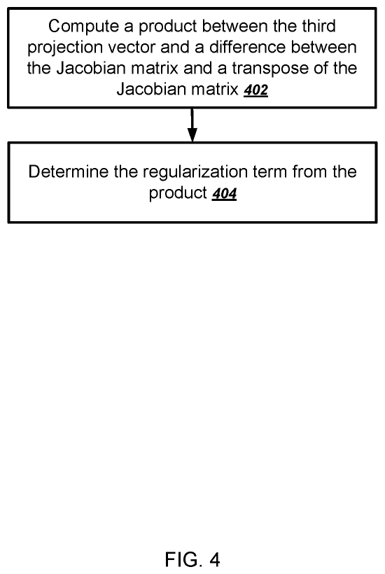

Thus, some implementations of the training system can determine this regularization term in a computationally efficient manner to avoid the excessive computational resource overhead that is otherwise required by exact computation by using one of following approximation techniques:
1—Bilinear projection error, which measures the deviation from symmetry using a bilinear form with two random projection vectors. Bilinear projection error approximation is explained in more detail with reference to FIG. 3, which shows sub-steps 302-308 corresponding to step 210.
2—Column projection error, which measures a norm of a symmetry difference matrix using a single projection direction. Column projection error approximation is explained in more detail with reference to FIG. 4, which shows sub-steps 402-404 corresponding to step 210.

FIG. 3 is a flow diagram of sub-steps 302-310 corresponding to step 210. FIG. 3 corresponds to determining the Jacobian symmetry regularization term in the form of a bilinear projection error that uses a first projection vector α and a second projection vector β in [symbol] .

There are many ways in which the first and second projection vectors can be generated. For example, the first and second projection vectors can each include values that are randomly sampled from a predetermined distribution, e.g., a standard normal N(0, I). As another example, the first and second projection vectors can each include values that are determined based on the training data items.

The training system computes a first product between the Jacobian matrix and the first projection vector (step 302). For example, the first product can be computed as J_{θ}(x)α.

The training system computes a second product between the Jacobian matrix and the second projection vector (step 304). For example, the second product can be computed as J_{θ}(x)β.

Thus, bilinear projection error approximation reduces the computational cost from d backward passes down to two forward-mode automatic differentiation passes through the generative neural network. In practice, this can involve applying two separate Jacobian-vector product (JVP) operations. A JVP operation is a computationally efficient operation that avoids the need to compute and store the full Jacobian matrix which conserves both processor and memory resources; the JPV operation directly evaluates the directional derivative of a training vector field along the specific direction of a projection vector.

The training system computes a third product between a transpose of the second projection vector and the first product (step 306). For example, the third product can be computed as β^{T}J_{θ}(x)α.

The training system computes a fourth product between a transpose of the first projection vector and the second product (step 308). For example, the fourth product can be computed as α^{T}J_{θ}(x)β.

The training system determines the Jacobian symmetry regularization term from a difference between the fourth product and the third product (step 310). For example, the Jacobian symmetry regularization term can be computed as

$${R}_{ξ} ( θ , x ) = {E}_{α , β} [ {ξ}_{θ}^{2} ( α , β , x ) ] , where$$

$$ξθ ( α , β , x ) {=}^{Δ} {α}^{T} {J}_{θ} ( x ) β - {β}^{T} {J}_{θ} ( x ) α .$$

In this example, the difference between the fourth product and the third product is a scalar error value that measures the deviation from symmetry for an input data item x given the two projection vectors. If the Jacobian matrix is perfectly symmetric, the inner product α^{T}J_{θ}(x)β will equal β^{T}J_{θ}(x)α, and this regularization term will vanish to zero.

FIG. 4 is another flow diagram of sub-steps 402-404 corresponding to step 210. FIG. 4 corresponds to determining the Jacobian symmetry regularization term in the form of a column projection error that uses a third projection vector μ in [symbol] . In some implementations, the third projection vector can include values that are randomly sampled from a predetermined distribution, e.g., a standard normal N(0, I).

There are many ways in which the third projection vector can be generated. For example, the third projection vector can include values that are randomly sampled from a predetermined distribution, e.g., a standard normal N(0, 1). As another example, the third projection vector can include values that are determined based on the training data items.

The training system computes a product between 1) the third projection vector and 2) a difference between the Jacobian matrix and a transpose of the Jacobian matrix (step 402). The subtraction of the transpose of the Jacobian matrix from the Jacobian matrix isolates the “error matrix” or the anti-symmetric component of the Jacobian matrix. If the Jacobian matrix is perfectly symmetric, the difference evaluates to zero. For example, the product can be computed as (J_{θ}(x)−J_{θ}^{T}(x))μ.

Thus, column projection error approximation reduces the computational cost from d backward passes down to one forward-mode pass (to compute Jμ) and one reverse-mode pass (to compute J^{T}μ) through the generative neural network. In practice, this can involve applying one Jacobian-vector product (JVP) operation and one vector-Jacobian product (VJP) operation.

The training system determines the Jacobian symmetry regularization term from the product (step 404). For example, the Jacobian symmetry regularization term can be computed as

$${δ}_{θ} ( θ , x ) = {E}_{μ} [ {δ}_{θ}^{2} ( μ , x ) ] , where$$

$${δ}_{θ} ( μ , x ) {=}^{Δ} {‖ ( {J}_{θ} ( x ) - {J}_{θ}^{T} ( x ) ) μ ‖}_{2} .$$

When the third projection vector μ is randomly sampled from a standard normal distribution, the expected value of the squared error may represent the Frobenius norm of a symmetry difference matrix defined as the difference between the Jacobian matrix and its transpose (expressed as

$${‖ {J}_{θ} ( x ) - {J}_{θ}^{T} ( x ) ‖}_{F}^{2} ) .$$

If the symmetry difference matrix is small (i.e., the Frobenius norm of the symmetry difference matrix is close to zero), the Jacobian matrix is close to being symmetric. If the Frobenius norm of the symmetry difference matrix is large, the Jacobian matrix is far from symmetric.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computing devices, the method comprising:
obtaining training data that comprises a plurality of training data items; and
training a generative neural network on the training data, wherein the training comprises, at each of a plurality of training iterations:
obtaining, from the training data, a batch of one or more training data items for the training iteration;
for each of the one or more training data items in the batch:
processing a training input that corresponds to the training data item and that includes an input data item using the generative neural network to generate a training vector field for the training data item;
determining a target vector field for the training data item; and
computing a Jacobian matrix for the training vector field; and
updating values of parameters of the generative neural network based on optimizing an objective function that includes, for each of the one or more training data items in the batch, (i) a task term that is based on the target vector field and (ii) a regularization term that approximates a deviation of the Jacobian matrix for the training vector field from a symmetric Jacobian matrix.

2. The method of claim 1, wherein the generative neural network is a flow matching neural network, wherein the input data item is a noisy representation of the training data item that comprises values each sampled from a noise distribution, and wherein the task term is a flow matching loss term.

3. The method of claim 2, wherein the training input comprises a conditioning input that characterizes one or more target characteristics of the training data item.

4. The method of claim 2, wherein updating values of parameters of the generative neural network based on optimizing the objective function comprises:
computing gradients of the flow matching loss term with respect to the parameters of the generative neural network;
computing gradients of the regularization term with respect to the parameters of the generative neural network; and
applying an optimizer to the gradients of the flow matching loss term and the gradients of the regularization term.

5. The method of claim 1, wherein the generative neural network is a diffusion neural network, wherein the input data item is a noisy representation of the training data item that is generated based on adding noise to the training data item in accordance with a noise schedule and a time step, and wherein the task term is a diffusion loss term.

6. The method of claim 5, wherein the training input comprises the time step.

7. The method of claim 5, wherein the training input comprises a conditioning input that characterizes one or more target characteristics of the training data item.

8. The method of claim 5, wherein the diffusion loss term is a score matching loss term or a diffusion denoising loss term.

9. The method of claim 5, wherein updating values of parameters of the generative neural network based on optimizing the objective function comprises:
computing gradients of the diffusion loss term with respect to the parameters of the generative neural network;
computing gradients of the regularization term with respect to the parameters of the generative neural network; and
applying an optimizer to the gradients of the diffusion loss term and the gradients of the regularization term.

10. The method of claim 1, wherein updating values of parameters of the generative neural network based on optimizing the objective function comprises:
determining the regularization term in a form of a bilinear projection error that uses a first projection vector and a second projection vector.

11. The method of claim 10, wherein determining the regularization term in the form of the bilinear projection error comprises:
computing a first product between the Jacobian matrix and the first projection vector;
computing a second product between the Jacobian matrix and the second projection vector; and
computing a third product between a transpose of the second projection vector and the first product;
computing a fourth product between a transpose of the first projection vector and the second product; and
determining the regularization term from a difference between the fourth product and the third product.

12. The method of claim 11, wherein computing the first and second products comprises computing Jacobian-vector products (JVPs).

13. The method of claim 11, wherein the first and second projection vectors are generated by sampling from a predetermined distribution.

14. The method of claim 1, wherein updating values of parameters of the generative neural network based on optimizing the objective function comprises:
determining the regularization term in a form of a column projection error that uses a third projection vector.

15. The method of claim 14, wherein determining the regularization term in the form of the column projection error comprises:
computing a product between the third projection vector and a difference between the Jacobian matrix and a transpose of the Jacobian matrix; and
determining the regularization term from the product.

16. The method of claim 1, wherein the training data item comprises one of: image data, audio data, text data, or video data.

17. One or more non-transitory computer storage media storing instructions that when executed by one or more computers cause the one or more computers to perform operations comprising:
obtaining training data that comprises a plurality of training data items; and
training a generative neural network on the training data, wherein the training comprises, at each of a plurality of training iterations:
obtaining, from the training data, a batch of one or more training data items for the training iteration;
for each of the one or more training data items in the batch:
processing a training input that corresponds to the training data item and that includes an input data item using the generative neural network to generate a training vector field for the training data item;
determining a target vector field for the training data item; and
computing a Jacobian matrix for the training vector field; and
updating values of parameters of the generative neural network based on optimizing an objective function that includes, for each of the one or more training data items in the batch, (i) a task term that is based on the target vector field and (ii) a regularization term that approximates a deviation of the Jacobian matrix for the training vector field from a symmetric Jacobian matrix.

18. A system comprising one or more computers and one or more storage devices storing instructions that when executed by the one or more computers cause the one or more computers to perform operations comprising:
obtaining training data that comprises a plurality of training data items; and
training a generative neural network on the training data, wherein the training comprises, at each of a plurality of training iterations:
obtaining, from the training data, a batch of one or more training data items for the training iteration;
for each of the one or more training data items in the batch:
processing a training input that corresponds to the training data item and that includes an input data item using the generative neural network to generate a training vector field for the training data item;
determining a target vector field for the training data item; and
computing a Jacobian matrix for the training vector field; and
updating values of parameters of the generative neural network based on optimizing an objective function that includes, for each of the one or more training data items in the batch, (i) a task term that is based on the target vector field and (ii) a regularization term that approximates a deviation of the Jacobian matrix for the training vector field from a symmetric Jacobian matrix.

19. The system of claim 18, wherein the generative neural network is a flow matching neural network, wherein the input data item is an interpolated version of the training data item and a noise tensor that comprises values each sampled from a noise distribution, and wherein the task term is a flow matching loss term.

20. The system of claim 18, wherein the generative neural network is a diffusion neural network, wherein the input data item is a noisy representation of the training data item that is generated based on adding noise to the training data item in accordance with a noise schedule and a time step, and wherein the task term is a diffusion loss term.
